(19) United States
(12) Patent Application Publication
(10) Pub. No.: US 2017/0100812 A1
(43) Pub. Date: Apr. 13, 2017

(54) Smooth Finish Tool

(71) Applicant: Richard W. Knutson, Germantown, WI (US)

(72) Inventor: Richard W. Knutson, Germantown, WI (US)

(21) Appl. No.: 15/049,101

(22) Filed: Feb. 21, 2016

Related U.S. Application Data
(60) Provisional application No. 62/241,006, filed on Oct. 13, 2015.

(51) Int. Cl. B24B 9/00; B24B 55/10; B23B 5/16; B24B 9/20

(52) U.S. Cl. CPC B24B 9/007; B24B 9/20; B24B 55/102; B23B 5/16; B23B 2215/72; B23B 2220/08; B23B 2226/61

(57) ABSTRACT

The smooth finish tool corrects pipe ends that need to be perpendicular to its length. A cylindrical guide wall has an open and closed end. The guide wall envelopes the pipe end. An abrasive surface, such as a sanding disc, is affixed to the closed end of the guide wall. The guide wall has a port or ports to allow material discard and air flow. Because of the rotational speed, friction and resultant heat will be created so air flow is necessary to prevent excess heat buildup. Since the guide wall will be dependent on the size of the pipe the user is sanding, the guide provides a stable applied-force angle. A shaft, such as an arbor, may allow for variably sized tool attachments. Once done finishing simply remove the guide from the pipe.

### CROSS-REFERENCE TO RELATED APPLICATIONS

This application claims priority to U.S. Provisional Patent Application No. 62/241,006, entitled “Smooth Finish Tool”, filed Oct. 13, 2015 by Richard W. Knutson, the entire contents of which is hereby incorporated by reference.

### BACKGROUND OF THE INVENTION

The present invention is in the technical field of tools. More particularly, the present invention is in the technical field of tools altering material including pipe, conduit, fittings, or other material. Currently there is no tool on the market that will provide a finished surface on said varied material when cut, bent, or otherwise modified.

### BRIEF SUMMARY OF THE INVENTION

The following is intended to be a brief summary of the invention and is not intended to limit the scope of the invention.

The present invention is a tool for users to provide a flush, finished surface free of burrs or other defects on material including pipes and conduit. The tool may either attach to a device such as a drill or be a stand-alone tool. A guide slides over the material end, enveloping said material end that has been cut or otherwise altered. The guide holds the material end in place. Inside the tool is an abrasive surface, typically opposite of the open end where material is inserted. Force is applied to create friction between the inserted material end and the abrasive surface. Through this force material fragments are removed to create a finished surface on the material end.

### BRIEF DESCRIPTION OF THE DRAWINGS

FIG. 1. Exploded Disassembled View. FIG. 1 shows the best mode of the present invention and is not intended to limit the scope of the invention. It exemplifies a usable tool attachment for a drill.
(2): Nut
(3): Abrasive surface
(4): Washer
(5): Arbor
(6): Lock washer
(7): Port; two in total

FIG. 2: Assembled Side View

FIG. 3: Cross Sectional Side Assembled View
(1): Guide

FIG. 3: Optional Arbor Close Up
(8): Top view of arbor
(9): Alignment pin
(10): Hex Shaft

FIG. 1 shows a disassembled exploded view. A guide is shown with two ports (7). (2) shows a securing device such as a nut. (3) is an abrasive surface that may vary in grinding capabilities such as grit for any specialized application. Additionally the surface may be replaceable. Additionally the surface may be a sandpaper disc. (4) shows an optional washer that provides better surface area tension while the invention is being rotated. (5) shows an optional shaft arbor that may affix to the base of all variably-sized tool guides. (6) shows a lock washer. (7) shows optional ports for material discharge and heat exchange.

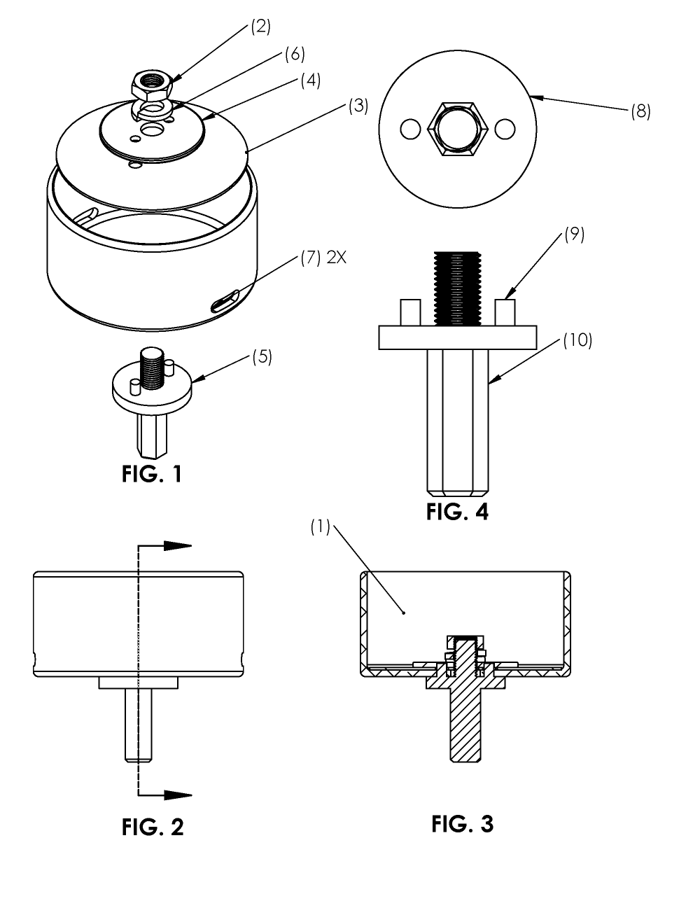

FIG. 2 shows an assembled side view.

FIG. 3 shows a cross sectional assembled view. (1) shows the vertical dimension of the guide wall being high enough wall to prevent slipping off the material.

FIG. 4 shows an optional arbor. (8) shows a top-down view of the arbor. (9) shows optional alignment pins that may assist in preventing part slippage during rotation. (10) shows one option for the arbor shaft shape in a hexagonal design for a drill chuck to clasp onto.

### DETAILED DESCRIPTION AND BEST MODE OF IMPLEMENTATION

In one embodiment and best mode, the present invention includes a cylindrical guide with one end open, an abrasive surface inside the guide, and a shaft which may be an arbor-type machinery tool affixed to the guide. An external means for rotation such as a drill may be used.

A guide fits over an alterable material, such as a PVC pipe. The best mode invention shows a guide in cylinder shape minimally larger in diameter than the material. The guide is minimally larger as to not allow the present invention to shift its axial orientation relative to the material. This fit enables the user to remove unwanted material through pressure from the close guide end toward the open end when the material is inserted. This results in a sanded, flush material end. Additionally, the guide may be used to house the other components.

Furthermore a guide may include a port or ports for venting and material discharge. When pressure is applied while the best mode invention is being rotated, friction is generated. To prevent pipe warping or deformation, the sanded debris should be discharged and ambient air be exchanged. The port or ports accomplish not only discharging material but provides heat outtake and ambient air intake. The port quantity and shape may vary; FIG. 1 demonstrates two elliptical holes.

The construction details of the guide are that the guide may be made of a PVC end cap or of any other sufficiently rigid and strong material such as high-strength alloy, metal, and the like. Further, the various components of the inventive tool can be made of the above or different materials.

An abrasive surface may be on the interior end of the guide cylinder opposite the opening. One embodiment of the abrasive surface is a sanding disk. The sanding disc adheres to the guide cylinder by an adhesive, a circumferential notch, friction, or other means. The sanding disc may be permanently installed or may be replaceable.

An arbor shaft may be affixed to the guide by threading, welding, or other means known by a person having ordinary skill in the art. In the best mode, the shaft connects the guide to the external rotation means such as a drill. FIG. 4 illustrates a standard arbor. (10) is a hex shaft of the arbor; it provides a non-slip design for a drill chuck to close onto. In the best mode invention, the arbor will be a standard drill shaft. (9) is an optional set of alignment pins that may help prevent slipping of parts during rotation.

The force may be applied rotationally as in the best mode case though it may be through vibration, longitudinal movement, latitudinal movement, or other directional force.

The process as shown in best mode follows. A shaft, shown as an arbor, is connected to a drill. The arbor is then connected onto the invention by threading it onto a guide. The guide is put over an altered PVC pipe until sandpaper disc makes contact with the PVC pipe end. Force is applied to maintain the PVC pipe and sandpaper disc mating, and the drill trigger engages to begin rotation. The rotating invention grinds down the PVC pipe end as long as force is applied. The grinding removes non uniform edges and burrs in a perpendicular orientation to the applied force. The guide enables the applied force to not shift. Sanded material exits the guide area through the port or ports. The grinding should stop once a finished, flush edge results that is as close to a manufacture edge as possible. The tool is pulled away and off from the material and the desired edge is achieved.

While the present invention has been described in terms of particular embodiments and applications, in both summarized and detailed forms, it is not intended that these descriptions in any way limit its scope to any such embodiments and applications, and it will be understood that many substitutions, changes and variations in the described embodiments, applications and details of the method and system illustrated herein and of their operation can be made by those skilled in the art without departing from the spirit of this invention.

The tool may attach to a drill, or it may be a stand-alone tool. One embodiment would be a permanently connected rotational force, such as a drill, connected to the tool. The tool may then be removable for different sizes. The shaft, such as an arbor, may be removable with a permanently affixed tool.

The invention claimed is:

1. A smooth finish tool comprising: a cylindrical guide with one end open;
said guide open end being minimally larger than a cylindrical alterable material to manipulate the smooth finish upon;
said guide containing an interior means to cut or grind said alterable material on the interior end of said cylindrical guide opposite the open end;
and a shaft to rotate said cylindrical guide about its height axis.

2. The smooth finish tool of claim 1, wherein the cylindrical guide includes a port or ports for air exchange and material discharge.

3. The smooth finish tool of claim 1, wherein the interior means to cut or grind is an abrasive surface such as a sanding disc.

4. The smooth finish tool of claim 1, wherein the interior means to cut or grind is a cutting blade or blades.

5. The smooth finish tool of claim 1, wherein the shaft is an arbor, also known as a tool mandrel.

6. The smooth finish tool of claim 5, wherein the arbor has an alignment pin or pins.

7. The smooth finish tool of claim 1, wherein the shaft can rotate by hand.

8. The smooth finish tool of claim 1, wherein the shaft can attach and be removed to a power tool.

9. The smooth finish tool of claim 1, wherein the cylindrical alterable material is PVC pipe.
